(19) United States
(12) Patent Application Publication
(10) Pub. No.: US 2022/0394997 A1
(43) Pub. Date: Dec. 15, 2022

(54) MEAT ANALOGUE COMPRISING LAB FERMENTED MATERIAL

(71) Applicant: FermentationExperts A/S, Baekke (DK)

(72) Inventors: Jens Høffner Legarth, Bække (DK); Soren Kjaerulff, Copenhagen (DK)

(73) Assignees: FermentationExperts A/S, Bække (DK); FermentationExperts A/S, Bække (DK)

(21) Appl. No.: 17/776,551

(22) PCT Filed: Nov. 13, 2020
(86) PCT No.: PCT/EP2020/081987

§ 371 Date: May 12, 2022

(30) Foreign Application Priority Data
Nov. 14, 2019 (DK) PA 2019 01336

(51) Int. Cl. A23J 3/20; A23L 11/50; A23L 33/135; A23L 33/105

(52) U.S. Cl. CPC A23J 3/20; A23L 11/50; A23L 33/135; A23L 33/105

(57) ABSTRACT

The present invention relates to the use of a fermented plant material; a fermented seaweed material or a combined fermented plant material and fermented seaweed material for the preparation of a meat analogue.

### TECHNICAL FIELD OF THE INVENTION

The present invention relates to the preparation of a meat analogue. In particular the present invention relates to a meat analogue produced from a fermented material, in particular a fermented plant material, a fermented seaweed material or a combination of a fermented plant material and seaweed material.

### BACKGROUND OF THE INVENTION

As the world population continuously increases the demand for proteinaceous foods and meat increases too. In 2050 it is estimated that 9-10 billion mouths should be feed, which requires larger facilities for growing food and farming animals, like cattle, while simultaneously such increased requirement has a negative environmental impacts because of factory farming, food is increasingly becoming a product of human design and meat analogues start to appear in supermarkets.

One way of providing such meat analogues is to “grow” it from animal muscle cells through tissue culture in controlled laboratory conditions. These are then combined with fat cells and additives for texture, flavour and colour. This process may take between two to six weeks.

With livestock farming accounting for about 18% of all greenhouse emissions, monopolizing about 70% of all arable land and about 46% of all crop-production for feed, and with an expected increase of 73% in global demand for meat products in 2050, the development meat analogues are desirable.

As meat analogues is produced under controlled processes there is no need for antibiotics which is often the case with livestock farming, and since the fat and cholesterol levels of meat analogues can be strictly controlled, there are also positive health implications with meat analogues

It is estimated that eating lab-grown meat also has a great impact on the environment, since livestock farming has a significant contribution to climate change and environmental degradation. Meat analogue processes are estimated to require 99% less land and 96% less water than livestock agriculture per kg “meat”, and an exclusive consumption of meat analogues could reduce greenhouse gas emissions by 74 to 87% versus traditional beef.

Meat analogues are also produced from plant materials, such as soy meat analogues are made primarily from soy proteins, wheat gluten and may contain carbohydrates. Soy meat analogues are made specifically to resemble meats, poultry or fish products in taste, texture, color and form.

However, there is a need for new improved products (meat analogue products) on the retail food market

Hence, a new and improved meat analogue would be advantageous. In particular, a meat analogue having meat like texture, reduced off flavours, without added preservatives or antibiotics, having health promoting properties and/or nutritional effects, and a meat analogue which is easily and efficiently produced and has a minimum impact on climate change and environmental degradation would be advantageous.

### SUMMARY OF THE INVENTION

Thus, an object of the present invention relates to a new and improved meat analogue.

In particular, it is an object of the present invention to provide a meat analogue and a process for providing a meat analogue that solves the above-mentioned problems of the prior art with meat like texture, off flavours, without the need to add preservatives or antibiotics. A meat analogue having health promoting properties and/or nutritional effects, and a meat analogue which is easily and efficiently produced and has a minimum impact on climate change and environmental degradation.

Thus, one aspect of the invention relates to a process for providing a meat analogue, the process comprises the steps of:
(i) providing a fermented material;
(ii) adjusting the moisture content of the fermented material provided in step (i) to 10-75% (w/w) moisture, providing a dough material;
(iii) optionally combining the dough material of step (ii) with an animal meat product and/or another protein source, providing a combined dough material; and
(iv) subjecting the dough material (obtained in step (ii)) or the combined dough material (obtained in step (iii)) to a first treatment, providing the meat analogue.

Another aspect of the present invention relates to a meat analogue comprising a fermented material and at least one lactic acid producing bacteria.

Yet another aspect of the present invention relates to a minced meat analogue comprising the meat analogue according to the present invention.

Still another aspect of the present invention relates to the use of a fermented material for the preparation of a meat analogue.

The present invention will now be described in more detail in the following.

### DETAILED DESCRIPTION OF THE INVENTION

Accordingly, the inventors of the present invention surprisingly found that a fermented material, such as a fermented plant material; a fermented seaweed material; or a combined fermented plant material and fermented seaweed material may be suitable for producing a meat analogue which has nutritional and health improving properties as well as allowing the control of texture and off flavours due to the fermentation conditions and at the same time has a minimum impact on climate change and environmental degradation.

Thus, a preferred embodiment of the present invention relates to a process for providing a meat analogue, the process comprises the steps of:
(i) providing a fermented material;
(ii) adjusting the moisture content of the fermented material provided in step (i) to 10-75% (w/w) moisture, providing a dough material;
(iii) optionally combining the dough material of step (ii) with an animal meat product and/or another protein source, providing a combined dough material; and
(iv) subjecting the dough material (obtained in step (ii)) or the combined dough material (obtained in step (iii)) to a first treatment, providing the meat analogue.

In the context of the present invention the term “meat analogue” relates to an animal meat substitute and may be called also called a meat alternative; meat substitute; mock meat; faux meat; imitation meat; vegetarian meat; or vegan meat.

In an embodiment of the present invention the meat analogue may be a plant-based meat analogue or a seaweed-based meat analogue a combined plant-based and seaweed-based meat analogue. Preferably, the plant-based meat may be a vegetable-based meat analogue.

The inventors of the present invention surprisingly found that fermentation of the starting material resulted in a fermented material having improved products and with increased content of excreted or liberated components from the plant material.

In an embodiment of the present invention the fermented material may be selected from a fermented plant material; a fermented seaweed material; or a combined fermented plant material and fermented seaweed material.

The fermented material may be provided by adding an inoculum comprising at least one lactic acid producing bacteria to a starting material providing an inoculated material.

In an embodiment of the present invention the fermented material may be provided by adding an inoculum consisting essentially of at least one lactic acid producing bacteria to a starting material providing an inoculated material.

In the context of the present invention the term “consisting essentially of” relates to the presence of amounts of other components in addition to the mandatory and defined components, and wherein the presence of the other components provided does not materially affect the essential characteristics composition, such as the inoculum.

In an embodiment of the present invention the fermented material may be provided by adding an inoculum consisting of at least one lactic acid producing bacteria to a starting material providing an inoculated material.

In the context of the present invention the term “consisting of” relates to a composition comprising no further features in the composition, e.g. the inoculum, apart from the ones following the wording.

In an embodiment of the present invention the starting material may be selected from a plant material; a seaweed material; or a combination of a plant material and a seaweed material. Preferably, the plant material may be a vegetable material.

The starting material may be subjected to fermentation in order to provide a fermented material. In the present context, the term “fermentation” or “fermented” relates to a controlled metabolic process of the material(s) to be fermented by adding a predetermined amount of inoculum to the starting material allowing the microorganism, in particular at least one lactic acid producing bacteria, and the starting material(s) to interact breaking down the material.

In a preferred embodiment of the present invention, the at least one lactic acid producing bacteria may be selected from the group consisting of the genus Enterococcus, Lactobacillus, Pediococcus, Lactococcus, or Bifidobacterium or combinations thereof.

In a further embodiment of the present invention, the at least one lactic acid producing bacteria may be selected from the group consisting of Pediococcus pentosaceus; Pendiococcus acidilactici; Lactobacillus plantarum, Lactobacillus rhamnosus, Enterococcus faecium, Lactobacillus acidophilus, Bifidobacterium lactis, Bifidobacterium longum, Bifidobacterium bifidum, Lactobacillus salivarius, Lactobacillus pentosus, Lactobacillus vaginalis, Lactobacillus xylosus and a combination thereof.

In an embodiment of the present invention, the at least one lactic acid producing bacteria may be the main microorganism present in the animal feed product. Even more preferably the main microorganism may be selected from the groups consisting of Pediococcus pentosaceus; Pendiococcus acidilactici, Lactobacillus plantarum, Lactobacillus rhamnosus, Enterococcus faecium, Lactobacillus acidophilus, Bifidobacterium lactis, Bifidobacterium longum, Bifidobacterium bifidum, Lactobacillus salivarius, Lactobacillus pentoses, Lactobacillus vaginalis, and Lactobacillus xylosus; preferably, the main lactic acid bacteria present in the composition is Lactobacillus plantarum.

In the context of the present invention, the term “main microorganism” relates to the microorganism present in highest amount, determined on a weight/weight ratio relative to the total number of microorganism present.

During fermentation, a group of microorganisms may be used for fermenting the plant material to provide a co-fermentation. The co-fermentation may be a mixture of different microorganisms (such as a mixture of yeasts, fungus, and/or bacteria) or a mixture of different bacteria. Preferably the co-fermentation comprises a mixture of different bacterial strains. In an embodiment of the present invention the co-fermentation comprises at least one lactic acid producing bacteria being the main microorganism, e.g. two or more lactic acid producing bacteria, such as three or more lactic acid producing bacteria, e.g. four or more lactic acid producing bacteria, such as 7 or more lactic acid producing bacteria, e.g. 10 or more lactic acid producing bacteria, such as 15 or more lactic acid producing bacteria, e.g. 20 or more lactic acid producing bacteria, such as 25 or more lactic acid producing bacteria, e.g. 30 or more lactic acid producing bacteria, such as 35 or more lactic acid producing bacteria, e.g. 40 or more lactic acid producing bacteria.

In a further embodiment of the present invention, the at least one lactic acid producing bacteria may be selected from the group consisting of one or more of Pediococcus pentosaceus (DSM 12834); Pendiococcus acidilactici (DSM 16243); Lactobacillus plantarum (DSM 12837); Enterococcus faecium (NCIMB 30122), Lactobacillus rhamnosus (NCIMB 30121), Pediococcus pentosaceus HTS (LMG P-22549), Pendiococcus acidilactici (NCIMB 30086) and/or Lactobacillus plantarum LSI (NCIMB 30083). Preferably, the one or more lactic acid bacteria stain(s) may be selected from the group consisting of one or more of Pediococcus pentosaceus (DSM 12834); Pendiococcus acidilactici (DSM 16243); Lactobacillus plantarum (DSM 12837).

The meat analogue and/or the fermented material may have a high content of viable lactic acid bacteria. In an embodiment of the present invention the meat analogue and/or the fermented material comprises one or more lactic acid bacterial strain(s) in a total amount in the range of 10⁵-10¹² CFU per gram of the animal feed product, such as in the range of 10⁶-10¹² CFU per gram, e.g. in the range of 10⁷-10¹¹ CFU per gram, such as in the range of 10⁸-10¹¹ CFU per gram, e.g. in the range of 10⁹-10¹⁰ CFU per gram.

In an embodiment of the present invention the meat analogue may constitute at least 10% (w/w) of the combination of the meat analogue and the animal meat; such as at least 20% (w/w); e.g. at least 30% (w/w); such as at least 40% (w/w); e.g. at least 50% (w/w); such as at least 60% (w/w); e.g. at least 70% (w/w); such as at least 80% (w/w); e.g. at least 90% (w/w); such as 100% (w/w).

In yet an embodiment of the present invention the fermented material may be provided with a high content of lactic acid (as defined herein) and/or a low pH value (as defined herein) providing a moistened fermented material which is stable for an extended period of time. Preferably, the extended period of time may be more than 5 days, e.g. more than 10 days, such as more than 15 days, e.g. more than 25 days. In the present context the term “stable” relates to a fermented material which remain the same, or substantially the same, chemically; texturally and/or structurally.

In a further embodiment of the present invention the fermented material may be subjected to a drying process, before the adjustment of the moisture content as described in step (ii) is performed. This drying process may be provided in order to improve control the moisture content (as adjusted in step (ii) and/or to improve product quality, since the fermented material may be stored for a period of time before it is used for providing the meat analogue.

Preferably, the fermented material may be subjected to a drying process, before the moisture content is adjusted as described in step (ii) or as part of adjusting the moisture content as described in step (ii).

In an embodiment of the present invention the moisture content of the fermented material may be adjusted, as described in step (ii) in order to provide a moisture content of the resulting meat analogue in the range of 35-70% (w/w), such as in the range of 40-65% (w/w), e.g. in the range of 45-60% (w/w), such as in the range of 50-55% (w/w).

Drying of the fermented material may preferably be performed by vacuum drying; spray drying; or spin flash drying. Preferably, drying of the fermented material may be performed as described in DK 2011 70489.

The process for providing a meat analogue may further comprise a step of adjusting the protein content of the meat analogue; the fermented material; the dough material; and/or the meat dough material to a protein content (of the meat analogue) in the range of 10-30% (w/w); such as in the range of 12-25% (w/w); e.g. in the range of 15-20% (w/w), such as about 17% (w/w).

In an embodiment of the present invention, the plant material may be selected from at least one proteinaceous plant material. The proteinaceous plant material may be a vegetable plant material, preferably, the vegetable plant material may be selected from eudicot plants, angiosperm plants, and/or rosid plants.

The proteinaceous plant material may include (fully or partly) a plant protein concentrate (comprising an increased concentration of protein relative to the naturally occurring plant material.

Preferably the proteinaceous plant material or the vegetable plant material may be selected from Brassicale plants, Fabales plants and/or root vegetables.

In an embodiment of the present invention the Brassicale plants is selected from the Brassicaceae family or the Cruciferae family.

In a further embodiment of the present invention, the Brassicaceae family or the Cruciferae family may be selected from at least one of a Brassica genus; sun flower; palm; soya, field beans, lupins; or a combination hereof. Preferably, at least one Brassica genus may be selected from one or more species such as Brassica napus; Brassica oleracea; Brassica campestris; Brassica nigra; Sinapis alba (Brassica alba); Brassica juncea; Brassica rapa or mixtures hereof.

In yet an embodiment of the present invention, the at least one Brassica genus may be selected from the group consisting of: including rape, rapeseed, canola, cabbage, broccoli, cauliflower, kale, Brussels sprouts, collard greens, savoy, kohlrabi, gai lan, white mustard, Indian mustard, Chinese mustard, and black mustard seed powder.

In an embodiment of the present invention the Fabales plants may be selected from Fabaceae or Leguminosae, such as the legume, the pea, or the bean family.

In yet an embodiment of the present invention the Fabales plants may be selected from soybean; pea; and/or Vicia faba.

The root vegetable may be selected from a solanale plant (in particular, solanale plant may be selected from the Solanaceae family, in particular from the genus Solanum, and specifically from the species S. tuberosum) and/or a malpighiale plant (in particular, malpighiale plant may be selected from the euphorbiaceae family, in particular from the genus Manihot, and specifically from the species M. esculenta). In an embodiment of the present invention the root vegetable may be selected from potato meal; potato protein concentrate; and/or potato flakes.

In an embodiment of the present invention the meat analogue comprises at least one seaweed material, such as at least two seaweed materials, e.g. at least three seaweed materials, such as at least four seaweed materials.

In an embodiment of the present invention, wherein the at least one fermented seaweed material may be a unicellular alga or a multicellular macroalgae.

In a further embodiment of the present invention, the multicellular macroalgae may be selected from brown macroalgae, red macroalgae, and/or green macroalgae.

The meat analogue may comprise at least one fermented plant material, such as at least two fermented plant materials, e.g. at least three fermented plant materials, such as at least four fermented plant materials.

In another embodiment of the present invention, the brown macroalgae may be selected from one or more of kelps, Saccharina latissima (Laminaria saccharina), Laminaria digitate, Ascophyllum nodosum, Laminaria hyperborean, or a mixture hereof.

A preferred embodiment of the present invention relates to a meat analogue comprising a fermented material and at least one lactic acid producing bacteria.

Preferably, the lactic acid producing bacteria may constitute at least 25% of the microbiota in the meat analogue; such as at least 40%; e.g. at least 50%; such as at least 60%; e.g. at least 75%; such as at least 85%; e.g. at least 90%; such as at least 95%; e.g. at least 98%; such as at least 99%; e.g. in the range of 25-99%; such as in the range of 50-98%, e.g. in the range of 75-95%.

Preservation of the meat analogue was found by the inventors of the present invention to be provided by the reduced pH value of the meat analogue.

In an embodiment of the present invention the meat analogue may have a pH value below 6.5; such as a pH value below 6.0; e.g. a pH value below 5.5; such as a pH value below 5.0; e.g. a pH value below 4.5; such as a pH value below 4.3; e.g. a pH value below 4.1; such as a pH value below 4.0.

The protein content has for years been important for the preparation of meat analogues. Thus, the concentration of protein in the fermented material may be improved. In an embodiment of the present invention the proteins of the fermented material have been isolated and provided in step (i).

In an embodiment of the present invention the protein content of the meat analogue may be in the range of 10-30% (w/w), such as in the range of 12-25% (w/w), e.g. in the range of 15-20% (w/w), such as about 17% (w/w).

Since the fermented plant material as provided in step (i) may comprise a protein content which is higher that required (or lower than required) the process according to the present invention may include a step of adjusting the protein content, such as a step of increasing the protein content, or such as decreasing the protein content of the meat analogue to a protein content in the range of 10-30% (w/w), such as in the range of 12-25% (w/w), e.g. in the range of 15-20% (w/w), such as about 17% (w/w).

Adjustment of the protein content may include a step of mixing the fermented material with a second plant material having a higher protein concentration than the fermented material (resulting in an increase of the protein content of the meat analogue); or a step of mixing the fermented material with a second plant material having a lower protein concentration than the fermented material (resulting in an increase of the protein content of the meat analogue). When mixing the fermented material with a second plant material, the second plant material may be a fermented second plant material.

Alternative ways to adjust the protein content of the meat analogue may be removal, of e.g. non-proteinaceous material; or by addition, e.g. adding protein concentrates; or addition of non-proteinaceous material.

The inventors of the present invention found that the fibrous material provided by the starting material(s) may have an important function in respect of consistency, texture, flavour and colour. Hence, in an embodiment of the present invention the fibrous material of the starting material may be maintained, or may be substantially maintained, in the fermented material provided in step (i).

Preferably, the meat analogue may comprise a fibre material. Preferably, the fibre material may be obtained from the fermented material and/or the starting material.

In the present context the term “substantially maintained” relates to maintaining at least 25% (w/w) of the fibrous material; such as at least 50% (w/w); e.g. at least 75% (w/w); such as at least 90% (w/w); e.g. at least 95% (w/w); such as at least 98% (w/w); e.g. at least 99% (w/w).

In an embodiment of the present invention the meat analogue comprises more than 5 g fibrous material originating from the starting material per kg meat analogue, such as more than 10 g fibrous material per kg meat analogue, e.g. more than 15 g fibrous material per kg meat analogue, such as more than 20 g fibrous material per kg meat analogue, e.g. more than 25 g fibrous material per kg meat analogue, such as more than 50 g fibrous material per kg meat analogue, e.g. more than 75 g fibrous material per kg meat analogue, such as more than 100 g fibrous material per kg meat analogue, e.g. more than 150 g fibrous material per kg meat analogue, such as more than 200 g fibrous material per kg meat analogue, e.g. more than 250 g fibrous material per kg meat analogue, such as more than 300 g fibrous material per kg meat analogue.

The fermentation process according to the present invention may provide sufficient preservation to the meat analogue. Hence, in an embodiment of the present invention the meat analogue does not comprise added preservatives.

In the present context the term “added preservatives” relates to preservatives added to the starting material and/or added to the fermented material and/or added to the meat analogue. Added preservatives may be isolate preservative compounds not formed during fermentation and/or contributing to the fermentation process.

The inventors of the present invention found that the meat analogue according to the present invention comprises nutritional and health promoting effects and these beneficial effects may be provided by the prebiotic and/or probiotic properties of the meat analogue.

During fermentation, various metabolites may be formed, which in combination, may assist in the enhancing the nutritional and antibiotic benefits from using the ingredient according to the present invention in the fermented material or in the meat analogue.

Hence, in an embodiment of the present invention the meat analogue comprises at least one metabolite from the fermented material; such as at least 2 metabolites; e.g. at least 3 metabolites; such as at least 5 metabolites; e.g. at least 10 metabolites; such as at least 20 metabolites; e.g. at least 30 metabolites; such as at least 50 metabolites; e.g. at least 100 metabolites.

In yet an embodiment of the present invention at least 10% (w/w) of the metabolite selected from an amino acid; a fatty acid; a bioactive phenol; a vitamin; an acid; a purine compound; a carbohydrate compound; a flavonoid compound; or a bacterial biomarker, produced or liberated during fermentation of the starting material, is included in the dough material of step (ii); such as at least 20% (w/w); e.g. at least 30% (w/w); such as at least 40% (w/w); e.g. at least 50% (w/w); such as at least 60% (w/w); e.g. at least 70% (w/w); such as at least 80% (w/w); e.g. at least 90% (w/w); such as at least 95% (w/w); e.g. at least 98% (w/w).

When the starting material is fermented using an inoculum comprising at least one lactic acid producing bacteria the pH value of the fermented material (or the meat analogue) may decrease. In an embodiment of the present invention the meat analogue may have a pH value below 6.5; such as a pH value below 6.0; e.g. a pH value below 5.5; such as a pH value below 5.0; e.g. a pH value below 4.5; such as a pH value below 4.3; e.g. a pH value below 4.1; such as a pH value below 4.0. Preferably, the drop in pH may be provided by the fermentation process, preferably no addition of acid may be made.

In an embodiment of the present invention the fermented material or the meat analogue has a content of lactic acid of at least 0.05% lactic acid relative to the fermented material or the meat analogue, such as at least 0.1% lactic acid relative to the fermented material or the meat analogue, such as at least 0.5% lactic acid relative to the fermented material or the meat analogue, e.g. at least 0.75% lactic acid relative to the fermented material or the meat analogue, such as at least 1% lactic acid relative to the fermented material or the meat analogue, e.g. at least 2.5% lactic acid relative to the fermented material or the meat analogue, such as at least 5% lactic acid relative to the fermented material or the meat analogue, e.g. at least 6% lactic acid relative to the fermented material or the meat analogue, such as at least 7.5% lactic acid relative to the fermented material or the meat analogue, such as in the range of 0.05-7.5% lactic acid relative to the fermented material or the meat analogue, such as in the range of 0.1-6% lactic acid relative to the fermented material or the meat analogue, such as in the range of 0.25-5% lactic acid relative to the fermented material or the meat analogue, such as in the range of 0.5-2.5% lactic acid relative to the fermented material or the meat analogue, such as in the range of 0.75-1% lactic acid relative to the fermented material or the meat analogue.

In a further embodiment of the present invention the meat analogue comprises benzoic acid.

The inventors found that fermentation of the starting material, when selected from a plant material, improved the flavour and the nutritional properties of the meat analogue because the amount of ANFs (Anti-Nutritional Factors) was significantly reduced from the fermentation process.

ANF may have a significant influence of the applicability of a plant material as a meat analogue, thus, reduction or removal (fully or partly) of the ANFs present in plant material may be relevant.

Anti-nutritional factors (ANFs) may be compounds or substances which act to reduce nutrient intake, digestion, absorption and utilization and may produce other adverse effects are referred to as anti-nutrients or anti-nutritional factor, like off flavour.

ANFs may include compounds like tannins; protease inhibitors, like trypsin or pepsin; oxalic acid and oxalates; glucosinolates; phytic acid; and/or saponins.

Fermenting plant materials and/or seaweed materials have shown to be an effective way of reducing or removing ANF's and the fermented material according to the present invention may accordingly comprise at most 75% (w/w) of the ANFs originally present in the plant material; such as at most 50% (w/w); e.g. at most 40% (w/w); such as at most 30% (w/w); e.g. at most 25% (w/w); such as at most 20% (w/w); e.g. at most 15% (w/w); such as at most 10% (w/w); e.g. at most 5% (w/w).

In the context of the present invention, the term reduction or removal of ANFs may relate to a deactivation or a restructuring of the ANFs.

Glycosinulates are one of the ANFs that is widespread in various plant materials and seaweeds.

In an embodiment of the present invention the content of glucosinolates present in the fermented material may be at most 75% (w/w) of the glucosinolates naturally present starting material, such as at most 50% (w/w), e.g. at most 40% (w/w), such as at most 30% (w/w), e.g. at most 25% (w/w), such as at most 20% (w/w), e.g. at most 15% (w/w), such as at most 10% (w/w), e.g. at most 5% (w/w).

In the present context, the term “glucosinolates naturally present in the at least one plant material” relates to a determined/analysed content of glucosinolates in the plant material to be fermented—before fermentation. If no determination or analysis of the plant material before fermentation has been made or can be made, the “glucosinolates naturally present in the at least one plant material” relates to the amount of glucosinolates to be found in the literature for the specific plant material.

In an embodiment of the present invention the fermented material may have a glucosinolate content of at most 100 μmol/g on a dry matter basis, such as at most 75 μmol/g on a dry matter basis, e.g. at most 50 μmol/g on a dry matter basis, such as at most 25 μmol/g on a dry matter basis, e.g. at most 15 μmol/g on a dry matter basis, such as at most 10 μmol/g on a dry matter basis, e.g. at most 7.5 μmol/g on a dry matter basis, such as at most 5 μmol/g on a dry matter basis, e.g. at most 2 μmol/g on a dry matter basis, such as at most 1 μmol/g on a dry matter basis, e.g. at most 0.5 μmol/g on a dry matter basis, such as 0 μmol/g on a dry matter basis.

The inventors found that the fermentation process of the starting material may be important to improve the quality of the fermented product for preparing the meat analogue. It was found that sufficient degradation may be important and at the same time avoid too long fermentation and degradation of the starting material, if additional nutritional and/or pharmacological effects are to be retained in the meat analogue and/or in the fermented material.

The process according to the present invention may involve addition of an inoculum to a starting material, providing an inoculated material. The inoculated material may be allowed to ferment, and the fermented material may be provided.

The proportion of the inoculum added to the starting material may vary. In case it is considered that the load of undesirable microbes are significant in the starting material or the fermentation system, the proportion of the inoculum in the fermentation mixture (inoculum+starting material+additional water) may be increased to insure that the fermentation is directed by the microbes (the lactic acid producing bacteria) of the inoculums. Thus, the inoculum may be provided with a concentration of lactic acid producing bacteria in the inoculum sufficient to outgrow other non-lactic acid bacteria, yeast or moulds, or pathogens present in the starting material.

Accordingly, in one embodiment of the invention, the proportion of the inoculum relative to the content of the starting material may be in the range of 0.1 to 99.9 vol-%; such as 1 to 99 vol-%; e.g. 5 to 70 vol-%; such as 10 to 50 vol-%; e.g. 25 to 35 vol-%; such as 0.1 to 10 vol-%; e.g. 0.5 to 5 vol-%; such as 1 to 2.5 vol-%; or around 1 to 2 vol-%.

The fermentation process according to the present invention, may preferably be essentially a homofermentative process. “Essentially homofermentative” means, that the predominant bacterial flora driving the fermentation is homofermentative towards producing lactic acid.

In the present context the term “essentially homofermentative” relates to a fermentation process where, 60% or more of the bacteria are homofermentative, such as 70% or more of the bacteria are homofermentative, e.g. 80% or more of the bacteria are homofermentative, such as 85% or more of the bacteria are homofermentative, e.g. 90% or more of the bacteria are homofermentative, such as 95% or more of the bacteria are homofermentative, e.g. 99% or more of the bacteria are homofermentative.

The term “homolactic fermentation” when used according to the present invention indicates that the major fermentation product is lactic acid, and the levels of acetic acid and ethanol are either below taste threshold, around taste threshold or slightly above taste threshold. Preferably, “essentially homofermentative” may indicate a ratio of lactic acid to acetic acid or lactic acid to ethanol in (mM/mM) of more than 1:1, such as 2:1 or more, e.g. 10:1 or more, such as 20:1 or more, e.g. 50:1 or more, or such as 100:1 or more.

It may be preferred that formation of acetic acid and/or ethanol during fermentation may be reduced or omitted since these products are considered to negatively affect the taste of the resulting meat analogue.

Hence, in order to reduce or avoid formation of acetic acid and/or ethanol during fermentation of the starting material of the present invention, oxygen, in particular gaseous oxygen, is removed (fully or partly) from the inoculated material.

The process of removing or depleting oxygen from the inoculated material may be performed during at least the first hour of the fermentation; such as within at least the first 2 hours of the fermentation; e.g. within the at least first 5 hours of the fermentation; such as within at least the first 10 hours of the fermentation; e.g. within the at least first 24 hours of the fermentation; such as within at least the first 2 days of the fermentation; e.g. within the at least first 5 days of the fermentation; such as during the entire fermentation process.

In an embodiment of the present invention the amount of oxygen present in, and/or surrounding, the inoculated material may be reduced in, or depleted from, oxygen by introducing gas depletion and/or vacuum. In the context of the present invention the term “gas depletion” relates to a process where a gas other than oxygen is introduced into the inoculated material and depletes (fully or partly) oxygen from the inoculated material. Alternatively, or additionally, the inoculated material may be reduced in, or depleted from, oxygen content by subjecting the inoculated material to a vacuum treatment.

The fermentation process of an oxygen depleted inoculated material may result in a fermented material with a reduced content or without a detectable amount of acetic acid and/or ethanol.

In an embodiment of the present invention the fermented material or the meat analogue may have a content of acetic acid or ethanol in the range of 0-1% acetic acid or ethanol relative to the fermented material or the meat analogue, such as in the range of 0.1-0.75% acetic acid or ethanol relative to the fermented material or the meat analogue, such as in the range of 0.25-0.5% acetic acid or ethanol relative to the fermented material or the meat analogue, such as in the range of 0.0001-0.001% acetic acid or ethanol relative to the fermented material or the meat analogue, such as in the range of 0.0005-0.05% acetic acid or ethanol relative to the fermented material or the meat analogue. Preferably, the fermented material or the meat analogue may have a non-detectable content of acetic acid or ethanol.

In yet an embodiment of the present invention the meat analogue has a content of acetic acid or ethanol of at most 100 mM; such as at most 50 mM; e.g. at most 25 mM; such as at most 10 mM; e.g. at most 1 mM; such as at most 0.1 mM; e.g. at most 0.01 mM; such as in the range of 0.01-100 mM; such as in the range of 0.1-75 mM; such as in the range of 1-50 mM; such as in the range of 5-25 mM; such as in the range of 1-10 mM.

In an embodiment of the present invention the inoculated material may be allowed to ferment for a period of at least 12 hours, e.g. for at least 24 hours, such as for at least 48 hours, e.g. for at least 72 hours, such as for at least 4 days, e.g. for at least 5 days, such as for at least 6 days, e.g. for at least 7 days, such as for at least 8 days, e.g. for at least 9 days, such as for at least 10 days, e.g. for at least 11 days, such as for at least 12 days, e.g. for at least 15 days, such as for at least 20 days.

In yet an embodiment of the present invention the inoculated material may be allowed to ferment for a period in the range of 12 hours to 40 days, e.g. for a period in the range of 24 hours to 30 days, such as for a period in the range of 2-25 days, e.g. for a period in the range of 5-20 days, such as for a period in the range of 7-15 days, e.g. for a period in the range of 10-13 days, e.g. about 11 days.

In a further embodiment of the present invention the inoculated material may be fermented at a temperature in the range of 15-45° C., such as 15-40° C., such as 25-35° C., such as 30-40° C., such as 15-20° C. or such as 40-45° C.

The moisture content of the starting material during fermentation or the inoculated material may preferably be in the range of 20-65% (w/w) moisture; such as in the range of 30-55% (w/w) moisture; e.g. in the range of 35-45% (w/w) moisture; such as about 40% (w/w) moisture.

Fermentation of a combination of the plant material and the seaweed material may involve an initial fermentation of the seaweed material followed by addition of the plant material followed by a second fermentation of the combined seaweed material and plant material providing a combined fermented plant material and fermented seaweed material.

In an embodiment of the present invention the fermentation process for providing the combination of a fermented plant material and the fermented seaweed material may be fermented separately or jointly.

If fermentation is performed jointly with the plant material and the seaweed material, the fermentation of the seaweed material may be started first and the plant material may be added subsequently. In an embodiment of the present invention the seaweed material may be subjected to fermentation for 1-15 days before the plant material is added; such as 3-12; e.g. 5-10; such as about 7 days before the plant material is added. When the plant material is added to the fermented plant material the fermentation may be continued with both the seaweed and the plant material for 2-20 days; such as for 4-16 days; e.g. for 8-13 days; e.g. for about 11 days.

In an embodiment of the present invention the fermented material may have a pH value below 6.5; such as a pH value below 6.0; e.g. a pH value below 5.5; such as a pH value below 5.0; e.g. a pH value below 4.5; such as a pH value below 4.3; e.g. a pH value below 4.1; such as a pH value below 4.0.

In order not to affect the starting material and in order to maintain the native metabolic nature of the materials, it may be preferred not to subject the starting material to any heat stabilization.

In an embodiment of the present invention the starting material and/or the fermented material is not subjected to temperatures above 100° C.; such as temperatures above 90° C.; e.g. temperatures above 80° C., such as temperatures above 70° C.; e.g. temperatures above 60° C., such as temperatures above 50° C.; e.g. temperatures above 45° C.

In a further embodiment of the present invention the starting material and/or the fermented material may be subjected to enzymatic treatment, e.g. by addition of a phytase.

Preferably, the starting material and/or the fermented material, may not subjected to enzymatic treatment other than addition of a phytase. Even more preferably, the starting material and/or the fermented material is not subjected to any enzymatic treatment.

In an embodiment of the present invention the meat analogue may comprise at least one metabolite from the fermented material; such as at least 2 metabolites; e.g. at least 3 metabolites; such as at least 5 metabolites; e.g. at least 10 metabolites; such as at least 20 metabolites; e.g. at least 30 metabolites; such as at least 50 metabolites; e.g. at least 100 metabolites.

Preferably, at least 10% (w/w) of the metabolite selected from an amino acid; a fatty acid; a bioactive phenol; a vitamin; an acid; a purine compound; a carbohydrate compound; a flavonoid compound; or a bacterial biomarker produced or liberated during fermentation of the starting material may be included in the dough material of step (ii); such as at least 20% (w/w); e.g. at least 30% (w/w); such as at least 40% (w/w); e.g. at least 50% (w/w); such as at least 60% (w/w); e.g. at least 70% (w/w); such as at least 80% (w/w); e.g. at least 90% (w/w); such as at least 95% (w/w); e.g. at least 98% (w/w).

In order to improve the fermentation process and/or in order to improve the texture and bite of the meat analogue, the starting material may be fractionized. Preferably the fermentation process (and/or the digestibility) may be improved by decreasing the particle size of the starting material but the desire to improve the fermentation of the starting material, may be balanced against the bit of the resulting meat analogue which has been found by the present inventors to disappear when the particle size gets too small, or when the fraction of small particles are getting too large, when proving meat analogues from a fermented plant material.

Thus, the inventor of the present invention surprisingly found that a specifically defined particle size of the starting material may be suitable for providing a meat analogue according to the present invention.

The particle size according to the present invention may be determined according the sieving methods whereby the particle size is defined by the mask of the sieve the particles may escape.

In an embodiment of the present invention the fractionized starting material may have an average maximum diameter (d50) of 5 mm, such as an average maximum diameter (d50) of 4 mm such as an average maximum diameter (d50) of 3 mm, such as an average maximum diameter (d50) of 2 mm, such as an average maximum diameter (d50) of 1 mm.

In a further embodiment of the present invention the fractionized starting material may have an average maximum diameter (d50) of 5 mm, such as an average maximum diameter (d50) of 4 mm such as an average maximum diameter (d50) of 3 mm, such as an average maximum diameter (d50) of 2 mm, such as an average maximum diameter (d50) of 1 mm and the fractionized starting material may have an average minimum diameter (d50) of 10 μm, such as an average maximum diameter (d50) of 50 μm such as an average maximum diameter (d50) of 100 μm, such as an average maximum diameter (d50) of 250 μm, such as an average maximum diameter (d50) of 500 μm, e.g. an average maximum diameter (d50) of 750 μm.

In yet an embodiment of the present invention the fractionized starting material may have an average diameter (d50) in the range 10 μm to 5 mm, such as 0.1 mm to 4 mm, such as an average diameter in the range of 0.25 mm to 3 mm, such as an average diameter in the range 0.5 mm to 2 mm, e.g. an average diameter in the range 0.75 mm to 1 mm.

In an embodiment of the present invention the starting material may subjected to at least one pre-treatment of the starting material resulting in the above mentioned average maximum diameter.

The at least one pre-treatment may involve disintegration, chopping, sheading, crushing, grinding, or the like of the starting material, in order to reduce the size of the at least one plant material and/or the at least one seaweed material.

In an embodiment of the present invention the pre-treatment may be performed on a dried, fresh or frozen starting material.

The meat analogue according to the present invention may preferably induce an increased nutritional effect and/or nutritional uptake of a consuming mammal.

The inventors of the present invention found that the best nutritional effect may be obtained from providing a balance between digestibility of the fermented material and stimulation of the intestinal microbiota and/or stimulation of the intestinal mucosa.

In order to meet this balance different fractions of particle sizes of the fermented material may be provided.

In a further embodiment of the present invention the fermented material comprises a range of 30-70% (w/w); such as a range of 40-60% (w/w); e.g. about 50% (w/w) of the dry fermented material has a particle size below 0.5 mm and a range of 30-70% (w/w); such as a range of 40-60% (w/w); e.g. about 50% (w/w) of the dry fermented material has a particle size above 0.5 mm.

In a further embodiment of the present invention the fermented material comprises at least 2, preferably at least 3, even more preferably at least 4 of the following criteria:
a) 1-10% (w/w), such as about 5% (w/w), of the dry fermented material has a particle size above 1.0 mm;
b) 45-55% (w/w), such as about 50% (w/w), of the dry fermented material has a particle size between 0.5-1.0 mm;
c) 30-40% (w/w), such as about 50% (w/w), of the dry fermented material has a particle size between 0.25-0.5 mm; and/or
d) 5-15% (w/w), such as about 10% (w/w), of the dry fermented material has a particle size below 0.25 mm.

In the present context the term “about” relates to a variation on the stated amount of 10% or less, such as 5% or less, e.g. 1% or less.

The selection of the various particle sizes may be determined by sieving as known to the skilled person.

In an embodiment of the present invention the fermented material may be mixed with at least one fat component; at least one additive for texture; at least one additive for flavour; at least one additive for odour; at least one additive for colour; or any combination hereof.

In an embodiment of the present invention the first treatment, providing the meat analogue (step (iv)) may involve creping of the dough material; extrusion of the dough material, such as thermoplastic extrusion, or wet extrusion or dry extrusion (having a moisture content below 15% (w/w), such as below 10% (w/w), e.g. below 7% (w/w)); fibre spinning of the dough material; and/or protein coagulation of the dough material, providing the meat analogue.

In a further embodiment of the present invention the meat analogue may be in the form of chunks; bites; flakes; mince; or granulate. The desired form of the meat analogue depends on the intended use of the meat analogue.

The meat analogue according to the present invention may be suitable for a minced meat analogue. An embodiment of the present invention relates to a minced meat analogue comprising the meat analogue according to the present invention.

In an embodiment of the present invention the minced meat analogue further comprises animal meat. Preferably, the animal meat is obtained from cattle; pig; horse; deer; sheep; goat; chicken; duck; or ostrich.

The minced meat analogue according to the present invention or the fermented material according to the present invention does not comprise an added preservative.

A preferred embodiment of the present invention relates to the use of a fermented material for the preparation of a meat analogue.

The fermented material may preferably be selected from a fermented plant material; a fermented seaweed material; or a combined fermented plant material and fermented seaweed material

The fermented material may be provided by adding an inoculum comprising lactic acid producing bacteria to a starting material. The starting material may preferably be selected from a plant material; a seaweed material; or a combination of a plant material and a seaweed material.

It should be noted that embodiments and features described in the context of one of the aspects of the present invention also apply to the other aspects of the invention.

All patent and non-patent references cited in the present application, are hereby incorporated by reference in their entirety.

1-10. (canceled)

11. A process for providing a meat analogue, the process comprises the steps of:
(i) providing a fermented material, wherein the fermented material is selected from a fermented plant material, a fermented seaweed material, or a combined fermented plant material and fermented seaweed material;
(ii) adjusting moisture content of the fermented material provided in step (i) to 10-75% (w/w) moisture, thereby providing a dough material;
(iii) optionally combining the dough material of step (ii) with an animal meat product and/or another protein source, thereby providing a combined dough material; and
(iv) subjecting the dough material (obtained in step (ii)) or the combined dough material (obtained in step (iii)) to a first treatment, thereby providing the meat analogue.

12. The process according to claim 11, wherein the meat analogue is a plant-based meat analogue a seaweed-based meat analogue, or a combined plant-based and seaweed-based meat analogue.

13. The process according to claim 11, wherein the fermented material comprises at least 2, preferably at least 3, even more preferably at least 4 of the following criteria:
a) 1-10% (w/w), such as about 5% (w/w), of dry fermented material has a particle size above 1.0 mm;
b) 45-55% (w/w), such as about 50% (w/w), of dry fermented material has a particle size between 0.5-1.0 mm;
c) 30-40% (w/w), such as about 50% (w/w), of dry fermented material has a particle size between 0.25-0.5 mm; and/or
d) 5-15% (w/w), such as about 10% (w/w), of dry fermented material has a particle size below 0.25 mm.

14. The process according to claim 11, wherein the fermented material is provided by adding an inoculum comprising at least one lactic acid producing bacteria to a starting material providing an inoculated material.

15. The process according to claim 11, wherein a fibrous material of a starting material is maintained, or is substantially maintained, in the fermented material provided in step (i).

16. The process according to claim 11, wherein a starting material and/or the fermented material is not subjected to temperatures above 100° C., temperatures above 90° C., temperatures above 80° C., temperatures above 70° C., temperatures above 60° C., temperatures above 50° C., or temperatures above 45° C.

17. The process according to claim 11, wherein the fermented material may be provided by an essentially homofermentative process.

18. A meat analogue comprising a fermented material and at least one lactic acid producing bacteria, wherein the fermented material is selected from a fermented plant material, a fermented seaweed material, or a combined fermented plant material and fermented seaweed material.

19. The meat analogue according to claim 18, wherein the at least one lactic acid producing bacteria constitutes at least 25%, at least 40%, at least 50%, at least 60%, at least 75%, at least 85%, at least 90%, at least 95%, at least 98%, at least 99%, in the range of 25-99%, in the range of 50-98%, or in the range of 75-95% of microbiota in a meat analogue.

20. The meat analogue according to claim 18, wherein the meat analogue comprises a ratio of lactic acid to acetic acid or lactic acid to ethanol in (mM/mM) of more than 1:1, 2:1, 10:1, 20:1, 50:1, or 100:1.

21. The meat analogue according to claim 18, wherein the meat analogue comprises at most 5% (w/w), 10% (w/w), 15% (w/w), 20% (w/w), 25% (w/w), 30% (w/w), 40% (w/w), 50% (w/w), or 75% (w/w) of anti-nutritional factors (ANFs) originally present in the plant material.

22. The meat analogue according to claim 18, wherein the fermented material comprises at least 2, preferably at least 3, even more preferably at least 4 of the following criteria:
a) 1-10% (w/w), such as about 5% (w/w), of dry fermented material has a particle size above 1.0 mm;
b) 45-55% (w/w), such as about 50% (w/w), of dry fermented material has a particle size between 0.5-1.0 mm;
c) 30-40% (w/w), such as about 50% (w/w), of dry fermented material has a particle size between 0.25-0.5 mm; and/or
d) 5-15% (w/w), such as about 10% (w/w), of dry fermented material has a particle size below 0.25 mm.

23. The meat analogue according to claim 18, wherein moisture content of the meat analogue is in the range of 35-70% (w/w), 40-65% (w/w), 45-60% (w/w), or 50-55% (w/w).

24. A minced meat analogue comprising the meat analogue according to claim 18.

25. Use of a fermented material for the preparation of a meat analogue, wherein the fermented material is selected from a fermented plant material, a fermented seaweed material, or a combined fermented plant material and fermented seaweed material; and
wherein the fermented material is provided by adding an inoculum comprising lactic acid producing bacteria to a starting material selected from a plant material, a seaweed material, or a combination of a plant material and a seaweed material.

26. Use of a fermented material for the preparation of a meat analogue wherein the fermented material is selected from a fermented plant material, a fermented seaweed material, or a combined fermented plant material and fermented seaweed material; and
wherein the fermented material comprises at least 2, preferably at least 3, even more preferably at least 4 of the following criteria:
a) 1-10% (w/w), such as about 5% (w/w), of dry fermented material has a particle size above 1.0 mm;
b) 45-55% (w/w), such as about 50% (w/w), of dry fermented material has a particle size between 0.5-1.0 mm;
c) 30-40% (w/w), such as about 50% (w/w), of dry fermented material has a particle size between 0.25-0.5 mm; and/or
d) 5-15% (w/w), such as about 10% (w/w), of dry fermented material has a particle size below 0.25 mm.
